(19) United States
(12) Patent Application Publication
(10) Pub. No.: US 2003/0168299 A1
(43) Pub. Date: Sep. 11, 2003

(54) Starter unit

(76) Inventors: Heinz Holler, Crallsheim (DE); Reinhard Kernchen, Satteldorf (DE); Achim Menne, Crailsheim (DE); Werner Klement, Heidenheim (DE)

Correspondence Address: BAKER & DANIELS, 111 E. WAYNE STREET, SUITE 800, FORT WAYNE, IN, 46802

(21) Appl. No.: 10/363,333

(22) PCT Filed: Jul. 16, 2001
(86) PCT No.: PCT/EP01/08183

(30) Foreign Application Priority Data
Aug. 31, 2000 (DE) 100 43 146.1
Mar. 2, 2001 (DE) 101 10 076.0
Mar. 21, 2001 (DE) 011 06 407.8

(51) Int. Cl. B60K 41/22

(52) U.S. Cl. 192/3.57

(57) ABSTRACT

The invention relates to a starter unit (1), comprising the following: an input (E) which may be coupled to a drive input; an output (A) which may be coupled to a drive output; a starter element (1) in the form of a hydrodynamic coupling comprising a pump wheel (4) and a turbine wheel (5) which together form a toroidal working chamber (6) and a pump wheel shell (10) which is coupled to the pump wheel (4) in a rotationally fixed manner; and a converter lockup clutch (7) comprising at least two clutch disks which may be brought into frictional functional engagement with each other, directly or indirectly, by means of further transmission means—a first clutch disk (8) and a second clutch disk (9). The first clutch disk (8) is rotationally fixed to the pump wheel shell (10) and the second clutch disk (9) is rotationally fixed to the turbine wheel (5). Means (11) for producing a contact force for producing the frictional connection between the first clutch disk (8) and the second clutch disk (9) are also provided.

The invention relates to a starter unit, specifically with the characteristics of the generic concept of claim 1; in addition, a transmission structural unit with a starter unit and a drive system with a starter unit designed according to the invention.

Many designs of starter units for use in shift transmissions, automatic shift transmissions, or automatic transmissions are known from the prior art. They include a hydrodynamic structural element in the form of a hydrodynamic rpm/torque converter (fluid drive) or a hydrodynamic coupling. With regard to a possible design of a starter unit for use in transmissions with a hydrodynamic coupling, reference is made to the document DE 198 04 635 A1. This document discloses a design of a starter unit with low axial structural length, comprising a pump wheel and a turbine wheel, which together form a toroidal working chamber, whereby the pump wheel is arranged on the motor drive output side, i.e. the turbine wheel is arranged spatially between an input of the starter unit and the pump wheel. For this purpose, the pump wheel is connected in a rotationally fixed manner to the input and/or to a drive coupled to the input, via an element which simultaneously forms the pump wheel shell. A converter lockup clutch is provided which is connected in parallel to the hydrodynamic coupling. It makes possible a transmission of power from the input of the starter unit to the output while bypassing the hydrodynamic structural element. The converter lockup clutch is thus arranged as a separate structural element next to the unit made of the pump wheel and turbine wheel. Furthermore, the starter unit comprises a device for damping vibrations, which is arranged in a diametral area located above the radial outer dimension of the toroidal working chamber of the hydrodynamic coupling and which is a component of the

converter lockup clutch and/or forms a coupling element. In other words, the device for damping vibrations is essentially arranged in the area of a plane or slightly offset from the hydrodynamic coupling. This solution is indeed built so that it is relatively short, but it does not fulfill the requirements of certain predefined installation situations with regard to the axial length. Furthermore, based on the many functional elements, this design is characterized by a large number of structural parts and a high assembly cost.

The purpose of the invention is thus to further develop a starter unit of the type named at the beginning, comprising a hydrodynamic coupling and a converter lockup clutch which are connected in parallel, in such a manner that it is characterized by a small construction space requirement in the axial direction and a small number of structural parts. The manufacturing cost should thus be kept as low as possible.

The solution according to the invention is characterized by the characteristics of claim 1. Advantageous embodiments are given in the dependent claims.

The starter unit comprises an input that can be coupled to a drive input mechanism and an output that can be coupled to a drive output (power take-off). Between the input and the output, a hydrodynamic coupling is arranged with a turbine wheel and a pump wheel, which together form a toroid-shaped working chamber. The pump wheel is thus allocated to a so-called pump wheel shell, which is connected to it so that it is rotationally fixed and encloses the turbine wheel in the axial direction. The pump wheel shell can be constructed as a single piece with the pump wheel, preferably however, multiple-part designs are used, whereby the rotationally fixed connection is made via corresponding

connection elements or other attachment possibilities. The starter unit contains, furthermore, a coupling that can be connected in the form of a converter lockup clutch, which is connected in parallel to the hydrodynamic coupling. This means that during a large part of the operation of the starter unit, the power transmission occurs via only one of the two elements—hydrodynamic coupling or converter lockup clutch. In the first case mentioned, the power transmission occurs via a hydrodynamic power branch using the advantages of hydrodynamic power transmission, while in the second case, the power transmission is essentially done mechanically by the mechanical transmission coupling. In the process, however, there is also the possibility that both elements, at least in the transition range, i.e. during the switch-over between hydrodynamic and mechanical power branch, are in contact together. This mutual contact however, is of a very limited duration and should not exceed certain predefined times. In an additional development of the basic concept according to the invention, both couplings—hydrodynamic coupling and mechanical coupling can participate together in the power transmission, i.e. both transfer a part of the overall power.

The switchable coupling, especially the converter lockup clutch, is designed as a mechanical coupling, preferably in a disk construction. This includes at least one first coupling element in the form of a coupling input disk, also called a first clutch disk, and one second coupling element in the form of a coupling output disk, also called a second clutch disk, which can be brought into frictional active connection with each other at least indirectly, i.e. either directly or indirectly via additional transfer mechanisms, for example, in the form of additional disks. According to the invention, an integration of components of the converter lockup clutch in the hydrodynamic structural element is planned. This is achieved in that a coupling element, usually a first clutch disk, is connected with the primary wheel shell so that it is rotationally fixed, while the other second clutch disk is connected with the turbine wheel so that it is rotationally fixed. Mechanisms for generating a contact force, and thus for generating an at least indirectly frictionally engaged connection between the first clutch disk and the second clutch disk, are allocated to the clutch disks.

The solution according to the invention makes possible, by integration of the individual elements of the converter lockup clutch into the starter element in the form of the hydrodynamic coupling, a design of a starter unit with a very low construction spatial requirement in the axial direction, since here actually existing structural elements are simultaneously given the task of taking over the function of the other element.

The mechanisms for generating a contact force comprise at least one piston element that can be impinged with a pressure medium. It can be allocated separately to the clutch disks. In an especially compact and thus advantageous embodiment, however, the turbine wheel is used as a piston element. The pressure space for impinging the piston element is formed by the part of the toroid-shaped working chamber enclosed by the turbine wheel. With regard to the constructive design for the transfer of the function of an element and furthermore, of an element of the mechanism for generating a contact force, essentially the following possibilities exist:

1. rotationally-fixed coupling of the turbine wheel with the output of the starter unit, but, axial shifting capability of the turbine wheel;

2. rotationally-fixed connection of the turbine wheel with the output of the starter unit and in the axial direction, elastic design of the coupling between the turbine wheel and output.

In the first case mentioned, the frictional connection, resulting indirectly via additional elements or directly, between the first clutch disk and the second clutch disk connected rotationally-fixed to the turbine wheel, is ensured through the shift of the turbine wheel, while in the second case, only a reversible deformation of the connection between the turbine wheel and the output of the starter unit allows the contact. The second solution is suitable only in designs with a small axial distance between the first and the second clutch disks in the uncoupled state, while the solution named first is also conceivable for larger separation distances. The axial shiftability of the turbine wheel thus occurs in a range from 0.1 to 2 mm.

In order to realize an almost automatic clutch lockup and in addition, a secure operational method for power transmission via the hydrodynamic coupling element, a counter-force is necessary for axial shiftability of the turbine wheel. This counter-force fixes the turbine wheel in its position relative to the pump blade wheel. This counter-force is generated according to the invention by operating medium supplied to the working chamber, which is supplied along the outer circumference of the turbine wheel between the individual clutch disks of the converter lockup clutch into the area of the separating plane between the pump wheel and the turbine wheel in the area of the outer diameter of the toroid-shaped working chamber and from there is introduced into the pump wheel. Customarily, both clutch disks are near to each other. The gap remaining functions as a throttle point for the operating medium flowing through. By this throttle, a pressure difference becomes established between the piston surfaces, from which the required

contact force results for the opening and closing for the clutch lockup. This can be realized in the simplest case for embodiments with rotationally-fixed connection and axial shiftability through the pre-tensioning of the turbine wheel, for example, using at least one spring device. This is also possible in a similar way for the elastic connection of the turbine wheel to the output, which is made in the axial direction. For the switch-over from the hydrodynamic operation to the mechanical drive, the operating medium supply is changed with respect to its direction, i.e. the flow going through is no longer done centripetally and instead is done centrifugally around the outer circumference of the turbine wheel. The counter-force that is active on the turbine wheel during centripetal flow by the operating medium between the clutch disks is caused to go away. The operating medium is then supplied to the toroidal working chamber in the area of the inner circumference and flows through the hydrodynamic coupling centrifugally. The pressure force generated by the operating medium on the turbine wheel causes a shift or tipping of the turbine wheel in the direction away from the pump wheel, whereby the clutch disk that is rotationally fixed to the turbine wheel is brought into a frictional active connection with the clutch disk coupled to the pump wheel shell.

With regard to the connection of the first and second clutch disks to the turbine wheel and/or the pump wheel shell, there are many possibilities. The spatial arrangement is made, when viewed in the axial direction, next to the toroidal working chamber and/or behind it. The arrangement in the radial direction is characterized by outer and inner dimensions, which are preferably in the area between the outer and the inner diameters of the toroidal working chamber. Preferably, the frictional surfaces formed from the clutch disks are aligned parallel to the separating plane between the pump wheel and the turbine wheel. Production engineering tolerances can be compensated for without problems.

Preferably, the rotationally fixed coupling with the turbine wheel is done directly on the rear side of the part of the turbine wheel that forms the torus. The rotationally-fixed connection of the individual clutch disks with the turbine wheel and the pump wheel and/or the pump wheel shell can also be achieved in different ways. Conceivable are

a) the single-piece design of clutch disks and turbine wheel and/or clutch disk and pump wheel shell;

b) construction of the individual clutch disks as separate structural elements and rotationally-fixed coupling via corresponding connection elements with the pump wheel and/or turbine wheel.

In both cases, the frictional surface can be formed directly by the clutch disk, i.e. in the first case mentioned, from the outer side of the turbine wheel and an inner surface of the pump wheel shell and in the second case, by the separate structural element or instead, by a frictional lining allocated to the outer circumference of the turbine wheel or the individual clutch disks.

The design of the hydrodynamic coupling involves a flow coupling, i.e. a structural element, which allows only one rpm conversion in the power transmission between a drive input and a drive output, i.e. relative to a converter, it is free from a conversion of the torque and thus is necessarily coupled to the rpm. It can be regulated or unregulated.

Regulated hydrodynamic couplings are couplings in which the level of filling during operation can be changed as desired between full filling and emptying, whereby the power consumption and thus the transmission capability of the coupling can be adjusted and when used in motor vehicles, it makes possible an infinitely variable load-dependent rpm control of the drive engine and/or drive output side. The hydrodynamic coupling can thus be formed as a coupling with a toroidal working chamber, which is formed by a primary blade wheel functioning as a pump wheel and a secondary blade wheel functioning as a turbine wheel, or constructed as a so-called double coupling, i.e. with two toroidal working chambers constructed of a primary blade wheel and a secondary blade wheel. The regulation capability is achieved primarily via the change of the mass flow, i.e. influencing the filling level in the working chamber and/or the operating medium circulation in the working circuit. The control and/or regulation of the filling level of the hydrodynamic coupling is thus done preferably via a pressure control. Thus, the change of the absolute pressure of the toroid-shaped working chamber is coupled with the filling level change. Thus, partial filling states can be set via the change of the absolute pressure.

An especially advantageous further development to ensure the sole and also the combined power transmission via both couplings—hydrodynamic coupling and switchable coupling—and controllability of at least one portion of the power that can be transmitted via one of the two couplings, consists in allocating to each of the two operating medium supply channels or spaces, which can be selectively used for supply or discharge, a controllable valve device for the control of the pressure, whereby via the absolute pressure that becomes set in the hydrodynamic coupling, the power transmission can be controlled via

the hydrodynamic coupling, while via the differential pressure, the power consumption of the switchable coupling can be set.

Under an additional especially advantageous aspect of the invention, the starter unit contains a device for damping vibrations, in particular, a torsion vibration damper. This torsion vibration damper is preferably arranged in the form of the hydrodynamic coupling on the hydrodynamic structural element and in series with the converter lockup clutch. This is achieved in that the device for the damping of vibrations is arranged between the turbine wheel and the output. This means that the turbine wheel is coupled to the input of the device for damping vibrations, or via the frictional connection for clutch lockup of the hydrodynamic power branch, the input of the device for damping vibrations is connected in a rotationally fixed manner to the pump wheel via the pump wheel shell. The arrangement of the device for damping vibrations is thus made spatially, as seen in the axial direction, essentially in the area or in a plane with the hydrodynamic structural element. In the radial direction, the device for damping vibrations is arranged within the part of the diameter that defines the hydrodynamic coupling and forms the inner circumference of the toroid-shaped working chamber. With this design, in addition to a especially short axial structural length, the structural space that is available in the radial direction is also optimally used. With regard to the design of the device for damping of vibrations, there are no restrictions, i.e. any type of vibration damper is conceivable. Devices for damping of vibrations which are only based on frictional damping or hydraulic damping devices are suitable for the application, for example. The design as a hydraulic damping device contains, in addition to a primary part and a secondary part, which can be coupled together in a rotationally-fixed manner for the purposes of torque transmission and which can be rotated opposite each other at a certain angle in the circumferential direction, mechanisms for the elastic and/or damping coupling between the primary part and the secondary part. The mechanisms for the damping coupling contain chambers that can be filled with hydraulic fluid, into which vibrations can be displaced. The device for damping vibrations must thus be designed only for the starting moment on the turbine wheel, which is why the device for damping vibrations is built very small in the radial and axial direction, and usually does not cause any enlargement of the dimensions of the starter unit which are specified by the hydrodynamic structural element.

Other possibilities for connection are also conceivable, for example, the arrangement of the torsion vibration damper in series with the switchable coupling, i.e. in front of it or behind it, or in front of the power branch.

With regard to the spatial arrangement of the pump wheel and turbine wheel relative to the input and output of the starter unit, there are essentially the following two possibilities:

1. arrangement of the pump wheel in the axial direction between the input of the starter unit and the turbine wheel of the hydrodynamic coupling;

2. arrangement of the turbine wheel of the hydrodynamic coupling in the axial direction between the input of the starter unit and the pump wheel.

Preferably, the last possibility mentioned is applied since in this case, in spite of low construction space, the collision possibilities of the individual elements can be optimally controlled.

The solution according to the invention is especially suitable for use in automatic transmissions. These can be shift transmissions or infinitely variable change-speed transmissions. The starter unit can be pre-mounted separately as a structural unit. The connection to the transmission is done by integration in the transmission housing or series connection with shift gear stages or in an infinitely variable change-speed transmission part, e.g. traction mechanism transmission or toroidal transmission, whereby in both cases, the coupling can be done, for example, by plugging onto a shaft that can be coupled to the subsequently connected gear stages and/or infinitely variable change-speed transmission part.

In an additional aspect of the invention, the starter unit according to the invention is suitable both for use in drive trains in stationary systems as well as motor vehicles.

The solution according to the invention is explained in greater detail in the drawings. They show the following:

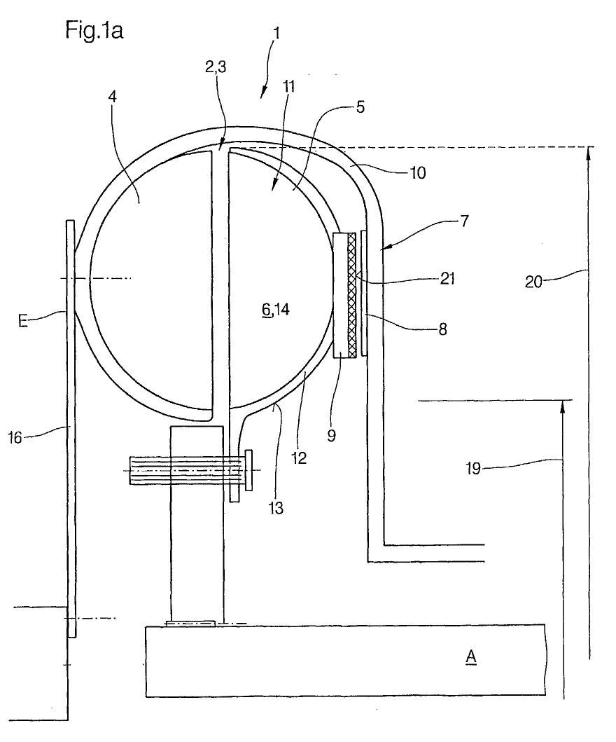

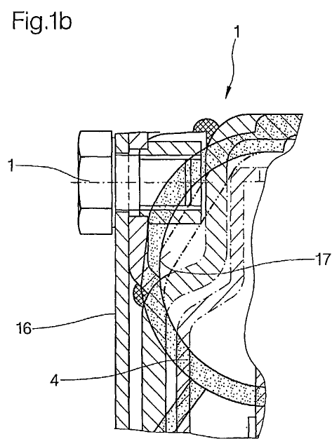

FIGS. 1a and 1b show an advantageous embodiment of a starter unit according to the invention;

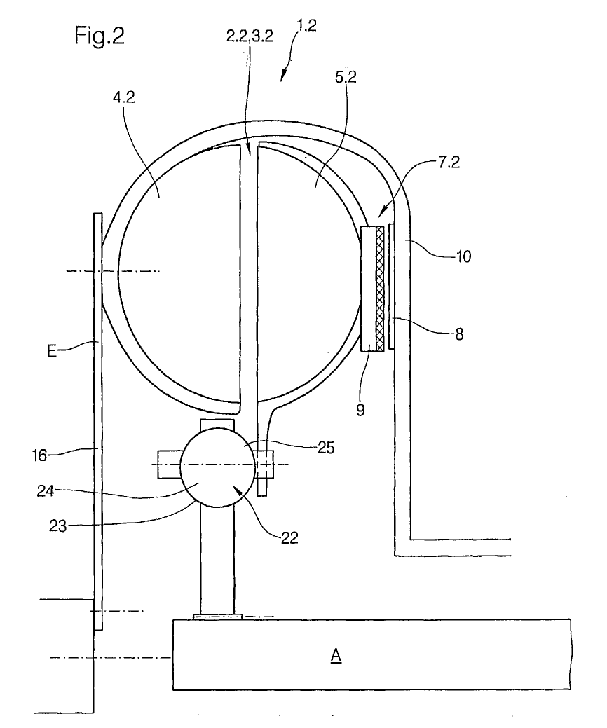

FIG. 2 shows an additional embodiment of a starter unit according to FIG. 1;

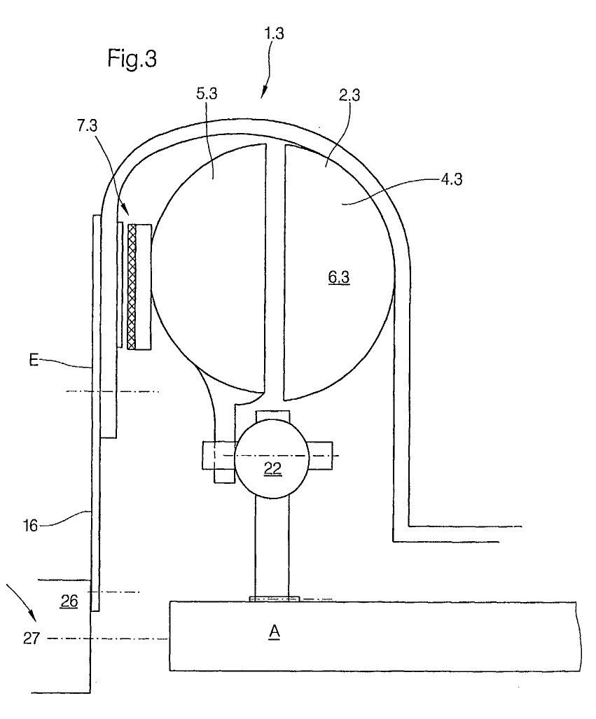

FIG. 3 shows an advantageous embodiment of a starter unit with blade wheels exchanged with regard to the designs according to FIG. 1 and FIG. 2;

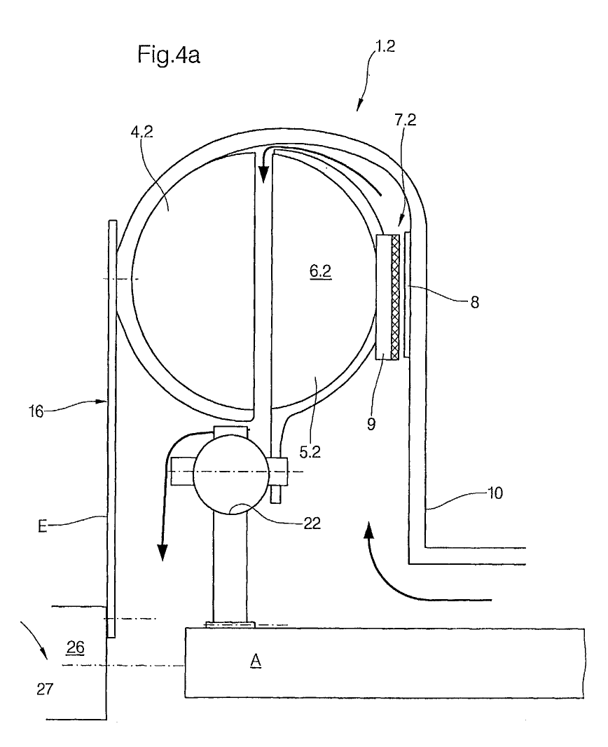

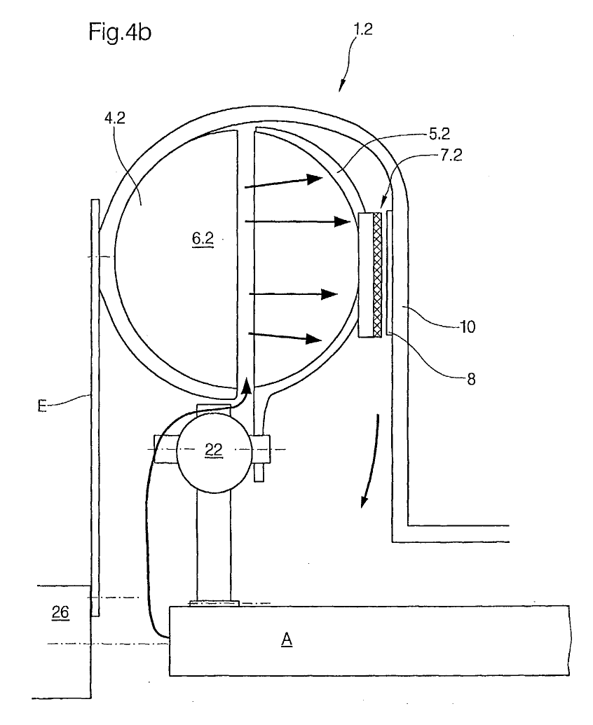

FIGS. 4a and 4b show the two states of flow going through, using a design according to FIG. 2;

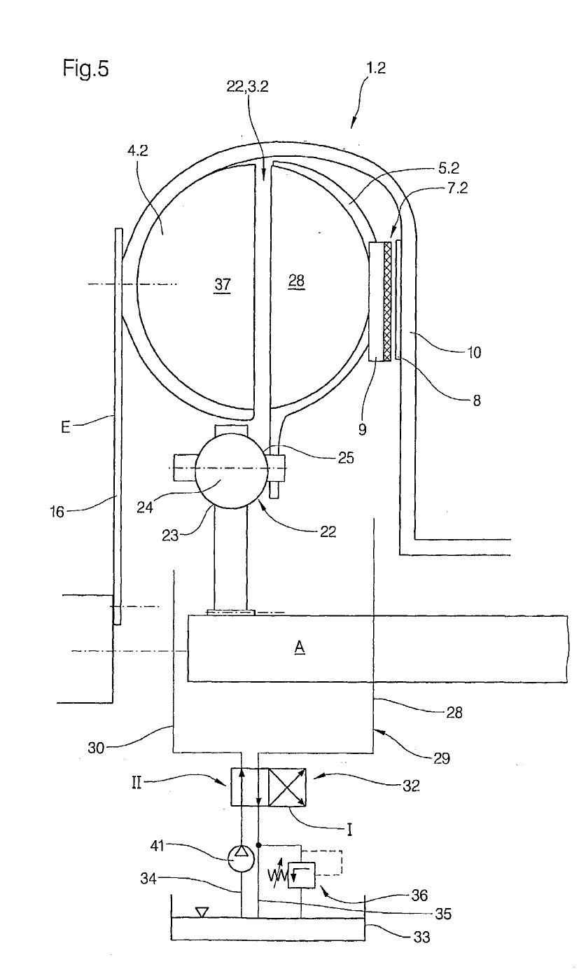

FIG. 5 shows in a schematically greatly simplified diagram, a possibility for realizing a pressure control;

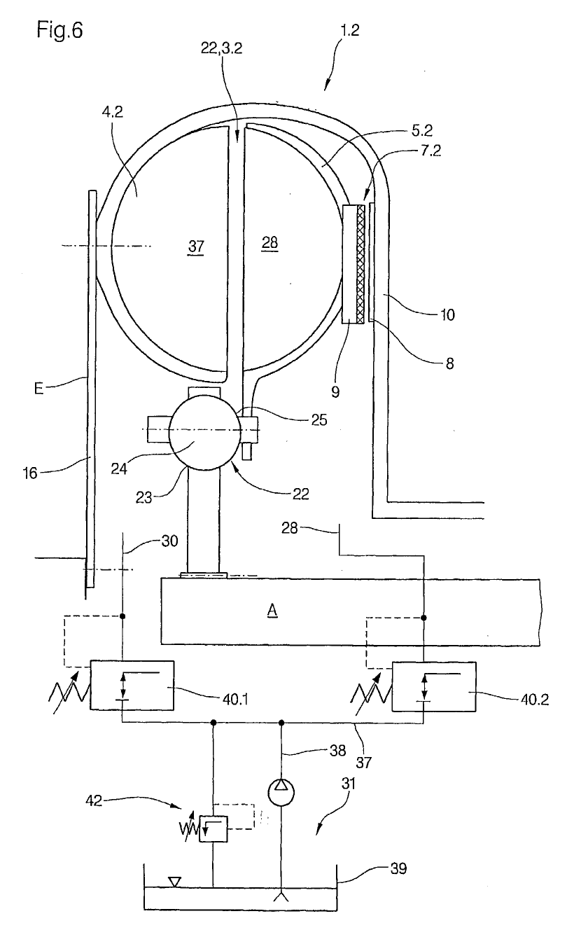

FIG. 6 shows a structural part simplification based on FIG. 5.

FIG. 1a shows, in a schematically simplified diagram, the basic structure of a starter unit 1 according to the invention. This unit contains one input E that can be coupled to the drive input, and one output A that can be coupled to the subsequently connected transmission gear stages, or to a drive output. The starter unit 1 contains a starter unit 2 in the form of a hydrodynamic coupling 3. The hydrodynamic coupling 3 contains two blade wheels, a primary wheel functioning as a pump wheel 4 and a secondary wheel functioning as a turbine wheel 5, which together form a toroidal working chamber 6. The starter unit 1 contains, furthermore, a converter lockup clutch 7 connected in parallel to the starter element 2 in the form of the hydrodynamic coupling 3. The converter lockup clutch is understood to be a switchable coupling device which makes a power transmission possible while bypassing a power branch, in a drive system with several power branches. The converter lockup clutch 7 contains at least two coupling elements that can be brought together into active frictional connection, preferably in the form of clutch disks—as seen in the power flow direction between the input E and the output A of the starter unit 1, a first clutch disk 8, which can also be described as a clutch input disk, and a second clutch disk 9, which can be described as a clutch output disk. An active

connection through friction between the first clutch disk 8 and the second clutch disk 9 can thus be made directly or indirectly, in the first case mentioned, the friction pair of the first clutch disk 8 and the second clutch disk 9 is formed, while in the second case, additional elements that carry frictional surfaces are connected intermediately. The pump wheel 4 contains a pump wheel shell 10. It is formed either by a separate structural element, which is coupled in a rotationally fixed manner to the pump wheel 4, or is designed as an integral structural unit with the pump wheel 4. The pump wheel shell 10 extends, in its installed position, in the axial direction essentially over the axial extension of the turbine wheel 5 and/or encloses it at least partially also in the radial direction. Preferably, the enclosure of the turbine wheel 5 is done by the pump wheel shell 10 and/or for a multi-part design of its individual parts, in such a way that they extend in the radial direction until the area of the output A. The turbine wheel 5 is connected directly or indirectly, i.e. via additional transmission elements, to the output A of the starter unit 1. According to the invention, the first clutch disk 8 is connected so that it is rotationally fixed to the pump wheel 4, in particular the pump wheel shell 10, while the second clutch disk 9 is coupled to the turbine wheel 5 so that it is rotationally fixed. Preferably, the arrangement of the converter lockup clutch 7 is made in the radial direction in the area of the radial extension of the toroid-shaped working chamber 6. According to the invention, additional mechanisms 11 are planned in order to generate a contact force in order to create a frictional connection between both clutch disks, the clutch disk 8 and the second clutch disk 9. The mechanisms 11 preferably include a piston element 12 that can be impinged with pressure medium, whereby the function of the piston element 12 according to the invention is taken over by the turbine wheel 5. The turbine wheel 5 is connected for this purpose either as shown in the drawing, rotationally affixed to the output A, but designed so that it can shift in the axial direction, or the connection to the output A is done in a directly rotationally fixed manner, torsion-proof in the circumferential direction and elastic in the axial direction. A design with axial shiftability is preferred, however. In order to ensure the functional method of the hydrodynamic coupling 3 during operation and thus the power transmission via the working circulation that becomes set in the toroid working chamber 6, the operating medium supply to the working chamber 6 occurs around the outer circumference 13 of the turbine wheel 5 and thus between the individual elements of the converter lockup clutch 7, i.e. at least between the first clutch disk 8 and the second clutch disk 9. The counter-force caused by the guide operation during the supply of the operating medium flow makes possible, during the power transmission into the hydrodynamic coupling 3, an axial fixing of the turbine wheel 5. If this counter-force goes away due to deflection or change of the supply of the operating medium flow to the working chamber, the operating medium causes, in the toroid-shaped working chamber 6, because of the pressure building in the working chamber 6, an axial force that is not supported by the turbine wheel 5 but instead leads to a shift of the turbine wheel 5 in the axial direction. This shift lies in an order of magnitude between 0.1 and 2 mm. The shift causes the two clutch disks, the clutch disk 8 and the second clutch disk 9, to be brought into frictional active connection with each other, so that the turbine wheel 5 is coupled mechanically to the pump wheel 4, whereby the piston element 12 impinged with a pressure force is integrated in the hydrodynamic coupling and, to be precise, is formed from the turbine wheel 5. In this process, the part of the turbine wheel 5 that carries second clutch disk 9 takes over the function of the piston element 12 and the operating medium located in the toroid-shaped working chamber 6 takes over the function of the pressure impingement, in a piston element 12, the function of the pressure chamber 14.

The embodiment shown in FIG. 1, of the starter unit 1, involves an especially advantageous arrangement of the individual elements—the pump wheel 4 and turbine wheel 5—of the hydrodynamic coupling 3. In it, in the power transmission direction between the input E and the output A of the starter unit 1, the turbine wheel 5 is arranged spatially behind the pump wheel 4 and/or next to it in the axial direction, whereas the pump wheel 4 is arranged spatially between the input E and the turbine wheel 5. Based on the integration of the mechanisms 11 for generating a contact force to create a frictional connection of the individual elements of the converter lockup clutch 7 into the hydrodynamic coupling 3, the number of required structural elements can be reduced to a minimum, since no additional separate device is necessary for generating and/or preparing the contact force for the individual elements, in particular, first clutch disk 8 and second clutch disk 9 of the converter lockup clutch 7. An additional advantage exists as a result of the integrated design with the short axial structural length. This can be reduced even further relative to the embodiments in the state of the art for optimized blade wheels with the solution according to the invention.

In view of reducing the axial construction space required, according to an advantageous additional embodiment of a solution according to the invention according to FIG. 1a, the connection of the pump wheel 4 to the drive input is done using attachment elements 15, whereby the drive input is made here via the coupling of so-called flexplates 16 to a crankshaft 26 of a drive engine 27 (not shown here in greater detail), i.e. with membranes that are flexible in the axial direction and torsion-proof in the circumferential direction. In order to reduce the axial structural length, it is provided according to the invention, that the attachment elements 15 extend partially into the blade base 17 of the pump wheel 4. This is made clear in FIG. 1b using a detail from a constructive embodiment of a

starter unit 1 according to FIG. 1a: Because of the torsion-proof connection between the drive input and/or the input E and the pump wheel 4, there is no relative movement between the attachment elements 15 and the pump wheel 4, in particular the blade base 17 of the pump wheel 4. Interference of the meridian flow that becomes set during the operation in the toroid-shaped working chamber 6 and/or an influencing of it, does not occur. This type of extension of the attachment elements 15 into the blade base 17 is shown in a detail using a excerpt section from a hydrodynamic coupling 3 designed according to the invention. From it, it is apparent that the area of the connection to the drive input, especially the flex plates 16 of the blade base 17, is characterized by other dimensions than in customarily known designs.

Preferably according to FIG. 1a, the second clutch disk 9 is arranged on the rear side 18 of the turbine wheel. The arrangement is made parallel to the separating plane between the pump wheel 4 and the turbine wheel 5, preferably in the area between the dimensions of the inner diameter 19 and the outer diameter 20 of the toroid-shaped working chamber 6. In this way, the second clutch disk 9 is formed directly from the turbine wheel 5, whereby the frictional surface 21 is generated from a lining applied onto the outer surface of the secondary wheel 5.

In an additional aspect of the invention, the starter unit 1.2 according to FIG. 2 includes a device for damping vibrations 22, in particular, a torsion vibration damper. It can have many designs, in the simplest case, it can be designed as a simple friction damper. However, designs are also conceivable with hydraulic damping. With regard to the concrete design of a device for damping vibrations 22, reference can be made to the designs known from the state-of-the-art. The concrete selection is at the discretion of the authorized professional. According to an especially advantageous embodiment, the hydrodynamic structural element, the hydrodynamic coupling 3.2, the converter lockup clutch 7.2 and the device 22 for damping vibrations are connected in series. The device for damping vibrations 22 includes a primary part 25, which is connected so that it is rotationally fixed with the turbine wheel 5, and with it, the second clutch disk 9 and a secondary part 23, which is coupled so that it is rotationally fixed with the output. Between the primary part 23 and the secondary part 23, mechanisms are provided for damping and elastic coupling 24. The device for damping vibrations 22 is arranged depending on the power transmission branch for the power transmission via the hydrodynamic coupling 3.2 between the hydrodynamic coupling 3.2, in particular the turbine wheel 5.2, and the output A, and furthermore, for power transmission via the converter lockup clutch 7.2, between the converter lockup clutch, especially the output of the converter lockup clutch formed by the second clutch disk 9 and the output A of the starter unit. In both cases, the device 22 is connected in series, to damp vibrations, after the respective power transmission element—hydrodynamic coupling 3.2 or converter lockup clutch 7.2. The remaining base structure of the starter unit 1.2 corresponds to the one described in FIG. 1a. For the equivalent elements, the same reference indicators are used.

FIG. 3 shows, in a schematically simplified diagram, an additional embodiment of a starter unit 1.3 designed according to the invention with a starter unit 2.3 in the form of a hydrodynamic coupling 3.3. The hydrodynamic coupling 3.3 also contains here a primary wheel 4.3 and a secondary wheel 5.3, which together form a toroid-shaped working chamber 6. Furthermore, a converter lockup clutch 7 is also provided, which is

connected in parallel to the hydrodynamic coupling 3.3. The basic function corresponds to the one described in FIGS. 1 and 2. For equivalent elements, the same reference indicators are used. In contrast with FIG. 1a and FIG. 2, however, the turbine wheel 5.3 is arranged, observed spatially in the axial direction, between the input E and the pump wheel 4.3, i.e. the pump wheel 4.3 is not arranged on the motor side, as opposed to the designs according to FIG. 1a and FIG. 2, but instead is arranged on the motor drive output side. The coupling between a drive input, in particular the input E of the starter unit 1.3 and the pump wheel 4.3 is then done with the inclusion of the secondary wheel 5.3 in the axial direction, whereby the connection of the turbine wheel 5.3 to the drive output via the output A is arranged in the radial direction within the intermediate space of the coupling between input E and pump wheel 4.3, and spatially observed between input E and output A of the starter unit, it is arranged prior to the coupling between the input E and the pump wheel 4.3.

In both designs according to FIG. 2 and FIG. 3, the device 22 for damping vibrations is arranged in installation position in the area beneath the toroid-shaped working chamber 6, i.e. within the radial inner diameter 19, which defines the radial inner dimension of the toroid-shaped working chamber 6.

This arrangement of the device 22 is possible, since with regard to the structural size, in particular, the dimensioning of the device 22 in order to damp vibrations, there is no necessity for over-dimensioning so that the maximum incident moment on the turbine wheel 5 is the moment on the pump wheel 4.

FIGS. 1 to 3 show advantageous designs of starter units 1, 1.2 and 1.3 made according to the invention. Additional functions can be realized by additional modifications and are

at the discretion of the authorized professional.

FIGS. 4a and 4b show, using an embodiment according to FIG. 2, the functional method of the starter unit 1.2 designed according to the invention. For equivalent elements, the same reference indicators are used. FIG. 4a shows the operating medium supply to the working chamber 6.2, during the hydrodynamic operation, i.e. power transmission via the hydrodynamic coupling 3.2 around the outer circumference of the turbine wheel to the separation plane between the pump wheel and the turbine wheel 5.2 in the area of the outer diameter of the toroid-shaped working chamber 6.2 and from there into the working chamber 6.2. FIG. 4b shows, on the contrary, the changed operating medium guidance, during the switch-over to the converter lockup clutch 7.2, to the turbine wheel 5.2 in the area of the inner circumference of the working chamber 6.2 for the purposes of pressure build up on the base of the blade of the turbine wheel 5.2 at the inner diameter of the toroid-shaped working chamber.

FIG. 5 shows, in a simplified schematic diagram, a preferred possibility for setting a partial filling of the hydrodynamic coupling 3.2 in a starter unit 1.2, as already described in FIGS. 1 to 3. The change of the filling level is done by pressure control. The guidance of the operating medium is done outside of the toroid-shaped working chamber 6.2 for the purposes of cooling via an open circulation 29.

The change of the flow-through of the hydrodynamic coupling 3.2, as shown in FIGS. 3 and 4, is done, for example, via a valve device 32, which sets the allocation of the individual operating medium-flow channels or lines to the supply and discharge according to the shift position. In the case shown, supply and discharge are each described by 28 and 30, whereby their coupling to the operating medium guide channels and spaces can be done as desired. In a first function position I of the valve device, the connection shown by 28 functions as a supply and the connection shown by 30 functions as a return. The connection shown by 28 is thus coupled to the channels (not shown in greater detail) for guiding the operating medium around the outer circumference of the turbine wheel. In this state, the coupled operating medium flow functions, when guided between the individual clutch disks 8 and 9 to be brought into frictional connection with each other, for deactivation of the converter lockup clutch 7.2. The hydrodynamic coupling is flowed through centripetally in this state. This means that a flow direction is to the center, into the center of the working circuit 37 that becomes set in the toroid-shaped working chamber. The connection 30 functions in this case for the flowing of the operating medium out of the toroid-shaped working chamber 6.2. In the second function position II of the 4/2 distributing valve device 32 shown in FIG. 5, the connection identified by 28 functions as an outlet and the connection identified by 30 functions as a supply. In this case, the operating medium is introduced centrifugally from the direction of the rotational axis into the toroid-shaped working chamber and causes the function shown in FIG. 4b. The turbine wheel 5.2 of the hydrodynamic coupling 3.2 functions as a piston element for the clutch disks 8 and 9 of the converter lockup clutch 7.2, which can be brought into frictional connection with each other. The open circulation 29 is conducted via a container 33. Coupled with this are a supply line 34 and a return line 35, which can be coupled via the valve device 32 selectively to the individual operating medium guide channels or spaces. The supply line 34 is allocated to the connection 30, the return line 35 forms the connection 28. To control the pressure, a controllable pressure limit valve 36 is provided in the return line 35, which can limit the pressure in the return line 35 to a certain value. For the supply with operating medium, a pumping device 41 is additionally provided.

Another possibility according to FIG. 6 consists in that the supply to the toroid-shaped working chamber 6.2 and the outlet from the toroid-shaped working chamber 6.2 are directly allocated to mechanisms for controlling the pressure. In this case, the supply and the outlet 30 and/or 28 from the toroid-shaped working chamber are coupled to each other via an connection line 37, which is coupled to an operating medium container 39 via an additional connection line 38. The control of the filling level in the toroid-shaped working chamber 6.2 of the hydrodynamic coupling 3.2 can thus be done by changing the absolute pressure p_{absolute} in the toroid-shaped working chamber 6.2. For this purpose, in the simplest case, the connections 28 and 30 acting as supply and outlet are coupled to each other via the connection line 37. In addition, the individual connections 28 and 30 are thus each controllable valve devices 40.1, 40.2 for the control of the pressures in the supply and return—each according to the allocation of the individual connections 28 and 30 as supply or outlet line. In the simplest case, they are designed, as shown in the drawing, as pressure regulator valves that can be controlled independently from one another. The connection lines 37 and 38 and the connections 28 and 30 and the operating medium containers 39 form an operating medium supply system 31. In order to prevent pump operation against the resistance of the valve devices 40.1 and 40.2, a pressure regulator valve 42 is provided.

List of Reference Indicators

List of Reference Indicators

| | |
|---|---|
| 1, 1.2, 1.3 | Starter unit |
| 2, 2.2, 2.3 | Starter element |
| 3, 3.2, 3.3 | Hydrodynamic coupling |
| 4, 4.2, 4.3 | Primary wheel |
| 5, 5.2, 5.3 | Secondary wheel |
| 6, 6.2, 6.3 | Toroid-shaped working chamber |
| 7, 7.2, 7.3 | Converter lockup clutch |
| 8 | First clutch disk |
| 9 | Second clutch disk |
| 10 | Pump wheel shell |
| 11 | Mechanism for generating a contact force in order create a |
| | frictional connection-indirectly or directly-between the first |
| | clutch disk and the second clutch disk |
| 12 | Piston element |
| 13 | Outer circumference |
| 14 | Pressure chamber |
| 15 | Attachment elements |
| 16 | Flex-plate |
| 17 | Blade base |
| 18 | Rear side |
| 19 | Inner diameter |
| 20 | Outer diameter |
| 21 | Frictional surface |
| 22 | Device for damping vibrations |
| 23 | Secondary part |
| 24 | Mechanism for damping and elastic coupling |
| 25 | Primary part |
| 26 | Crankshaft |
| 27 | Drive engine |
| 28 | Connection |
| 29 | Open circuit |
| 30 | Connection |
| 31 | Operating mechanism supply system |
| 32 | Valve device |
| 33 | Container |
| 34 | Supply line |
| 35 | Return line |
| 36 | Pressure limiter valve |
| 37 | Connection line |
| 38 | Connection line |
| 39 | Operating medium container |
| 40.1; 40.2 | Controllable valve devices |
| 41 | Pump device |
| 42 | Pressure release valve |
| E | Input |
| A | Output |

1. Starter unit (1, 1.2, 1.3)
1.1 with an input (E) which may be coupled to a drive input and an output (A) which may be coupled to the drive output;
1.2 with a starter element (2, 2.2, 2.3) in the form of a hydrodynamic coupling (3, 3.2, 3.3), comprising a pump wheel (4, 4.2, 4.3) and a turbine wheel (5, 5.2, 5.3) which together form a toroidal working chamber (6, 6.2, 6.3) and a pump wheel shell (10) which is coupled to the pump wheel (4, 4.2, 4.3) in a rotationally fixed manner;
1.3 with a converter lockup clutch (7, 7.2, 7.3) comprising at least two clutch disks—a first clutch disk (8) and a second clutch disk (9)—which may be brought into frictional functional engagement with each other, directly or indirectly, by means of additional transmission mechanisms;
characterized by the following:
1.4 the first clutch disk (8) is rotationally fixed to the pump wheel shell (10) and the second clutch disk (9) is rotationally fixed to the turbine wheel (5, 5.2, 5.3);
1.5 with mechanisms (11) for producing a contact force for producing a frictional connection that is at least indirect, between the first clutch disk (8) and the second clutch disk (9);
1.6 the mechanisms for producing a frictional connection that is at least indirect, between the first clutch disk (8) and the second clutch disk (9), comprise at least one piston element (12) that can be impinged with pressure medium and is formed from the turbine wheel (5, 5.2, 5.3);
1.7 the turbine wheel (5, 5.2, 5.3) is connected so that it is rotationally fixed, but can be shifted in the axial direction, with the output (A) of the starter unit (1, 1.2, 1.3);
1.8 a chamber (14) that can be filled with pressure medium for impingement of the piston element (12) is formed from the toroid-shaped working chamber (6, 6.2, 6.3);
1.9 with mechanisms for guiding the operating medium for the hydrodynamic coupling (3, 3.2, 3.3) along the outer circumference (13) of the secondary wheel (5, 5.2, 5.3);
1.10 the counter-force for setting the individual clutch disks (8, 9) off at a distance from the converter lockup clutch (7, 7.2, 7.3) is created by the operating medium;
1.11 the second clutch disk (9) is arranged on the rear side (18) of the turbine wheel (5, 5.2, 5.3);
1.12 the power consumption of the hydrodynamic coupling can be set as desired by changing the filling level.

2. Starter unit (1, 1.2, 1.3) according to claim 1, characterized in that the mechanisms (11) for producing the contact force include mechanisms for changing the operating medium guidance, in particular for the supply to the inner circumference of the toroid-shaped working chamber (6) outside of the outer circumference (21) of the turbine wheel (5.2).

3. Starter unit (1, 1.2, 1.3) according to one of the claims 1 or 2, characterized in that:
3.1 the first clutch disk (8) and/or the second clutch disk (9) are designed as a single piece with the pump wheel shell (10) and/or the turbine wheel (5, 5.2, 5.3);
3.2 the pump wheel shell (10) and/or the turbine wheel (5, 5.2, 5.3) are coated with a friction lining.

4. Starter unit (1, 1.2, 1.3) according to one of the claims 1 to 3, characterized in that:
4.1 the first clutch disk (8) and/or the second clutch disk (9) are designed as separate structural elements, which are connected in a rotationally fixed manner to the pump wheel shell (10) and/or the turbine wheel (5, 5.2, 5.3);
4.2 the frictional surface is formed from a separate structural element or a friction lining applied onto it.

5. Starter unit (1, 1.2, 1.3) according to claim 4, characterized in that the second clutch disk (9) is arranged in the radial direction in an area between the outer diameter (20) and the inner diameter (19) of the toroid-shaped working chamber (6, 6.2, 6.3).

6. Starter unit (1, 1.2, 1.3) according to one of the claims 1 to 5, characterized in that the first clutch disk (8) and the second clutch disk (9) are aligned parallel to the separating plane between the pump wheel (4, 4.2, 4.3) and the turbine wheel (5, 5.2, 5.3).

7. Starter unit (1, 1.2, 1.3) characterized by:
7.1 a device for damping vibrations (22), especially a torsional vibration damper;
7.2 the device for damping vibrations (22) is connected in series with the hydrodynamic coupling (3, 3.2, 3.3) and the converter lockup clutch (7, 7.2, 7.3).

8. Starter unit (1, 1.2, 1.3) according to claim 7, characterized in that the device for damping vibrations (22) is arranged between the turbine wheel (5, 5.2, 5.3) and the output (A).

9. Starter unit (1, 1.2, 1.3) according to one of the claims 7 or 8, characterized in that the device for damping vibrations (22) is designed as a frictional damping device.

10. Starter unit (1, 1.2, 1.3) according to one of the claims 7 or 8, characterized in that the device for damping vibrations (22) is designed as a hydraulic damping device.

11. Starter unit (1, 1.2, 1.3) according to claim 10, characterized in that:
11.1 the device for damping vibrations (22) contains a primary part (25) and a secondary part (23), which are coupled to each other in the circumferential direction in a rotationally fixed manner, but can be rotated opposite each other in a limited manner;
11.2 between the primary part (25) and a secondary part (23), mechanisms for vibration and/or elastic coupling (24) are arranged.

12. Starter unit (1, 1.2, 1.3) according to one of the claims 1 to 11, characterized in that the turbine wheel (5, 5.2, 5.3) is arranged spatially between the input (E) and the pump wheel (4, 4.2, 4.3).

13. Starter unit (1, 1.2, 1.3) according to one of the claims 1 to 12, characterized in that the turbine wheel (5, 5.2, 5.3) is arranged spatially behind the pump wheel (4, 4.2, 4.3) and the pump wheel (4, 4.2, 4.3) is arranged between the input (E) and the turbine wheel (5, 5.2, 5.3).

14. Starter unit (1, 1.2, 1.3) according to one of the claims 1 to 13, characterized in that the hydrodynamic coupling (3, 3.2, 3.3) can be controlled and regulated.

15. Starter unit (1, 1.2, 1.3) according to claim 14, characterized in that the hydrodynamic coupling (3, 3.2, 3.3) can be operated by pressure control.

16. Transmission structural unit with a starter unit (1, 1.2, 1.3) according to one of the claims 1 to 15.

17. Transmission structural unit according to claim 16, characterized in that the output (A) of the starter unit (1, 1.2, 1.3) is coupled to at least one subsequent shift gear stage.

18. Transmission structural unit according to one of the claims 16 or 17, characterized in that the output of the starter unit is coupled to an infinitely variable change-speed transmission.

19. Transmission structural unit according to one of the claims 16 or 18, characterized in that it is designed as an automatic transmission.

20. Drive system
20.1 with a drive engine;
20.2 with a starter unit (1, 1.2, 1.3) according to one of the claims 1 to 19 that can be coupled at least indirectly to the drive engine.

21. Drive system with a transmission structural unit according to one of the claims 16 to 19.

22. Drive system according to one of the claims 20 or 21 for use in a motor vehicle.

23. Drive system according to one of the claims 20 or 21 for use in a stationary system.
